(19) United States
(12) Patent Application Publication
(10) Pub. No.: US 2015/0081561 A1
(43) Pub. Date: Mar. 19, 2015

(54) MULTI-PARTY TRANSACTION PAYMENT NETWORK BRIDGE APPARATUS AND METHOD

(71) Applicant: MasterCard International Incorporated, Purchase, NY (US)

(72) Inventors: Paul Michael Musser, Pilot Hill, CA (US); Stefany Bello Lopez, White Plains, NY (US); Melisa Rose Favuzza, O'Fallon, MO (US); Kathryn Lynn Genereux, Brooklyn, NY (US); April DuBois, Great Falls, VA (US); Venu Appana, Lexington, MA (US)

(21) Appl. No.: 14/554,402

(22) Filed: Nov. 26, 2014

Related U.S. Application Data
(63) Continuation-in-part of application No. 14/485,390, filed on Sep. 12, 2014.
Application No. 14/485,390 is a continuation-in-part of application No. 14/308,400, filed on Jun. 18, 2014.
(60) Provisional application No. 61/909,152, filed on Nov. 26, 2013.
(60) Provisional application No. 61/876,896, filed on Sep. 12, 2013.
(60) Provisional application No. 61/836,588, filed on Jun. 18, 2013.

(51) Int. Cl. G06Q 20/04; G06Q 20/40

(52) U.S. Cl. CPC G06Q 20/0457; G06Q 20/40
USPC 705/44

(57) ABSTRACT

A system, method, and computer-readable storage medium configured to enable commodity voucher transactions.

### RELATED APPLICATIONS

This patent application claims priority to U.S. Provisional Patent Application Ser. No. 61/909,152 filed on Nov. 26, 2013, which is incorporated herein by reference, and entitled “Multi-Party Transaction Payment Network Bridge Apparatus and Method,” is also a continuation in part of U.S. patent application Ser. No. 14/485, 390, entitled “NGO Electronic Transaction Management System and Method,” filed on Sep. 12, 2014, which claims priority to provisional U.S. Patent Application Ser. No. 61/876,896, with the same title, filed on Sep. 12, 2013, and is also a continuation in part of U.S. patent application Ser. No. 14/308, 400, entitled “Multi-Party Transaction Payment Network Bridge Apparatus and Method,” filed on Jun. 18, 2014, which claims priority to provisional U.S. Patent Application Ser. No. 61/836,588, with the same title, filed on Jun. 18, 2013.

### BACKGROUND

1. Field of the Disclosure

Aspects of the disclosure relate in general to financial services. Aspects include an apparatus, system, method and computer-readable storage medium to enable commodity voucher transactions.

2. Description of the Related Art

For centuries, financial transactions have used currency, such as banknotes and coins. In modern times, however, payment cards are rapidly replacing cash to facilitate payments. A payment card is a card that can be used by an accountholder and accepted by a vendor or merchant to make a payment for a purchase or in payment of some other obligation. An example of a payment card includes a stored-value card (such as a transit card or gift card), credit card, debit card, automatic teller machine (ATM) card, or charge card.

Payment cards are affiliated with payment networks, which are operational networks that enable monetary exchange between parties.

While payment cards are increasingly used throughout the world, globally there remain 2.5 billion adults who are currently excluded from the formal financial system. In addition, while (in 2011) cross-border funders committed at least US$25 billion to microfinance or financial services for the poor, over 200 million micro-to-medium enterprises in developing economies lack access to affordable financial services and credit.

In a non-financial context, a voucher is a certificate or bond that is worth a certain value. For example, vouchers may be used for housing, travel, or food.

### SUMMARY

Embodiments include a system, device, method and computer-readable medium to enable commodity voucher transactions.

In a method of processing an electronic voucher transaction, electronic voucher information is read with an electronic voucher interface. The electronic voucher information contains a cardholder identifier, and a number of unredeemed electronic vouchers. A processor totals a number of goods or services to be redeemed with an electronic voucher, calculates the number of vouchers required to redeem the number of goods or services, and compares the number of unredeemed electronic vouchers and the calculated number of vouchers required to redeem the number of goods or services. The processor denies the electronic voucher transaction when the number of unredeemed electronic vouchers is less than the calculated number of vouchers required to redeem the number of goods or services.

### BRIEF DESCRIPTION OF THE DRAWINGS

FIG. 1 depicts an electronic voucher transaction system configured to process non-monetary transactions, and to perform financial transactions that traverse a Non Governmental Organization (NGO) network with a payment network.

FIG. 2 illustrates an example electronic voucher card with a photograph of an aid recipient.

FIGS. 3A-C depict an electronic voucher device. FIG. 3A shows an electronic voucher device displaying a menu selection embodiment. FIG. 3B illustrates an electronic voucher device displaying pictograms or pictures as part of an authentication process embodiment. FIG. 3C is a block diagram of the electronic voucher device embodiment.

FIG. 4 is a block diagram of a mobile point-of-sale device embodiment.

FIG. 5 is a block diagram of a NGO network embodiment.

FIG. 6 is a block diagram of a payment network configured to process electronic restricted cash vouchers that traverse the NGO network.

### DETAILED DESCRIPTION

One aspect of the disclosure includes the realization that a payment processor may be used to enable commodity voucher transactions. Such transactions include restricted commodity vouchers, restricted cash vouchers, and network restricted cash vouchers.

In another aspect of the disclosure, a payment processor may be used to facilitate secure financial transactions involving vouchers.

Another aspect of the disclosure includes the realization that a payment network system may be used to provide restricted commodity vouchers or restricted cash vouchers. Such a system leverages a payment network to track and report, rather than process payments. Such a system may be used to provide restricted commodity vouchers or restricted cash vouchers for non-governmental organizations (NGOs).

An aspect of the disclosure includes the understanding that many aid recipients that receive vouchers are illiterate, rendering conventional password or personal identification number (PIN) techniques ineffective.

A further aspect of the disclosure is the realization that aid vouchers may be used to train aid recipients on using the modern financial system. Electronic vouchers may be used as the gateway to using payment cards and payment accounts by former aid recipients.

Embodiments of the present disclosure include a system, method, and computer-readable storage medium configured to enable commodity voucher transactions. In some embodiments, vouchers may be used as electronic cash vouchers.

In some embodiments, a system is configured to enable trading of restricted commodity vouchers, restricted cash vouchers, and network restricted cash vouchers.

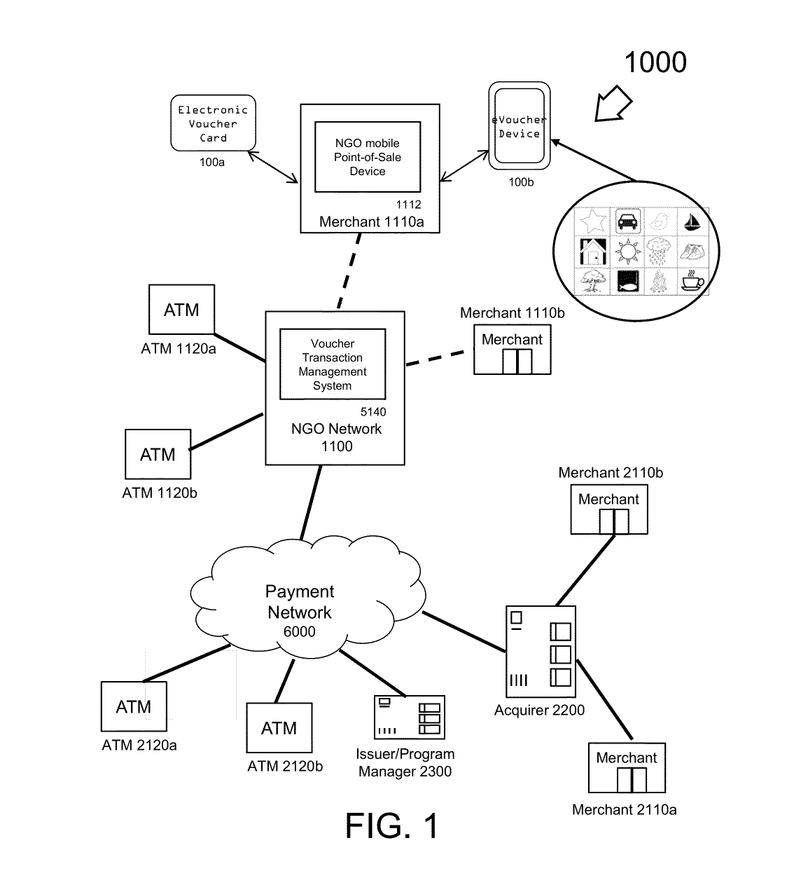

FIG. 1 depicts an electronic voucher transaction system 1000 configured to process non-monetary transactions, and to perform financial transactions that traverse a Non-Governmental Organization (NGO) network 1100 with a payment network 6000, constructed and operative in accordance with an embodiment of the present disclosure.

The system described herein enables electronic vouchers 100 (e-Voucher or e-voucher), which can be embodied as electronic voucher cards 100a or electronic voucher devices 100b. Electronic voucher cards 100a or electronic voucher devices 100b may be distributed by NGOs to aid recipients. While embodiments described herein are described in an NGO aid context, it is understood that the technology and embodiments may have other applications, such as healthcare, transit, agriculture, social benefits or other closed-loop or semi-closed-loop voucher applications.

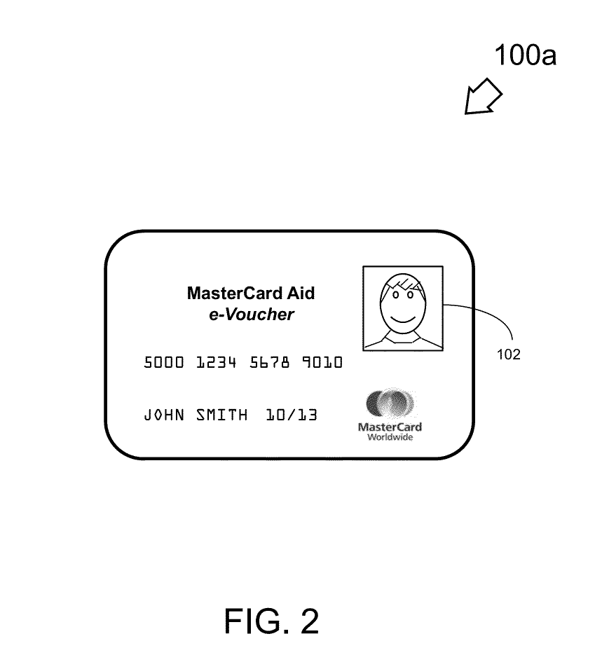

As shown in FIG. 2, an electronic voucher card 100a is a physical card, constructed and operative in accordance with an embodiment of the present disclosure. Electronic voucher card 100a is similar to a conventional payment card and may be encoded with a magnetic stripe on the opposite side (not shown) or contain a chip encoded with electronic voucher information. The electronic voucher information may include the number of unredeemed vouchers and an electronic image of the aid recipient. The electronic image of the aid recipient may be a Graphics Interchange Format (GIF), Joint Photographic Experts Group (JPEG), or other image format known in the art. Additionally, the electronic voucher card 100a may have a photograph 102 of the aid recipient to provide another verification of the aid recipient's identity. The photograph 102 may be the same image as the electronic image or an alternate image.

An electronic voucher device 100b may be an electronic wallet, mobile phone, tablet computer, or virtual account device capable of storing an electronic voucher. An example electronic voucher device 100b embodiment will be described in greater depth below.

An aid recipient may use an electronic voucher 100 at selected merchants 1110a-b approved by the NGO. The NGO may restrict the electronic vouchers for a selected basket of goods or selections from the merchant 1110.

Because the merchants 1110 may be located in a disaster-stricken area with unreliable communication with the NGO network 1100, the electronic voucher transaction occurs using the electronic voucher and an NGO mobile point-of-sale (POS) device 1112. At the time of a voucher transaction, the number of unredeemed vouchers and the electronic image are read by or transmitted to the NGO mobile point-of-sale device 1112. The merchant 1110 then uses the electronic image to verify the identity of the aid recipient and provides the goods or services specified by the voucher program. Alternatively, in embodiments that use an electronic voucher device 100b, aid recipients may be asked to type in a visual personal identification image (VPII), an authentication using pictograph or image selection or sequence. The VPII is selected by the aid recipient in advance of the voucher transaction. During authentication, the aid recipient selects the images that constitute the VPII. In some embodiments, the VPII may require images to be selected sequentially; in other embodiments, the selection of images need not be sequential, but all the images of the VPII must be identified. The images or pictographs used may vary from one disaster-relief area to another. In yet other embodiments, a numeric personal identification number (PIN) may be used. Embodiments may adopt a combination of authentication solutions, such as photo identification and a numeric PIN, for example.

In alternate embodiments, where direct communication with the NGO network is possible, NGO may distribute electronic vouchers to aid recipients for use at NGO-approved merchants 1110a-b, and ATMs 1120a-c. Transactions that take place within entities connected to the NGO network 1100 are processed by NGO network 1100 and its voucher transaction management system 5140.

In parallel, payment network 6000 also processes financial transactions on an interbank network 2100, where payment card acquirer financial institutions 2200 (“acquirer”) and issuer financial institutions 2300 (“issuer”) may be connected.

Payment network 6000 is a payment network capable of processing payments electronically over NGO network 1100. An example payment network 6000 includes MasterCard International Incorporated of Purchase, N.Y. Payment network 6000 may analyze and score financial transactions for the probability of fraud. The transaction scores may be expressed as a probability of fraud from zero (entirely fraudulent) to one (100% chance of no fraud), or scored between zero (fraudulent) and 1,000(100% not fraudulent).

An acquirer 2200 is a bank, credit union, or other financial institution configured to process transaction data from merchants 2110a-b and prepares authorization formatted data for the payment network 6000. Merchants 2110 are any vendors that accept payment cards or payment accounts.

An issuer 2300 is the bank, credit union, or other financial institution that provides the credit for the financial payment transaction. Issuer 2300 processes data (authorization requests), forwarded from the acquirer 2200 by interbank network 2100, and prepares the authorization formatted response (approvals/declines). In the following description, issuer 2300 acts as a program manager for a NGO payment network. A program manager is an entity, such as the non-governmental organization, that provides the aid voucher/token or other representation of the aid. Program manager contracts with a merchant 1110 to redeem the voucher, compensating merchant 1110 for their services, and sets the conditions for the voucher program. In the following example, issuer 2300 is a program manager. It is understood that in some embodiments, a program manager and issuer may be different entities. In some embodiments, issuer 2300 may be directly connected to the NGO network 1100.

In addition, automated teller machines 2120a-b may also be coupled to interbank network 2100.

Electronic vouchers leverage a payment network embodiment where the infrastructure embodiment is used for tracking and reporting rather than payment. In such an embodiment, transactions do not move money; instead, the embodiment leverages a payments infrastructure to track and report on data and information flows. In other words, there is no payment settlement over the network.

In such an embodiment, an open payment network:
Does not require payment sanctioning for acquiring and issuing entities;
Does not require fiduciary accounts;
Allows for open competition because the network uses standard and open protocol; and,
Less need for regulatory challenges as there is no need to monitor and regulate the movement of money (i.e., solution could be deployed for aid relief in a sanctioned country).

Embodiments may use a traditional payments infrastructure, but do not require payment to flow over the network. Rather, the payments infrastructure tracks and collects data.

As this is not a monetary transaction, it allows for a broader list of participants on the merchant and consumer side.

Such an embodiment allows for a single implementation on which multiple players can engage.

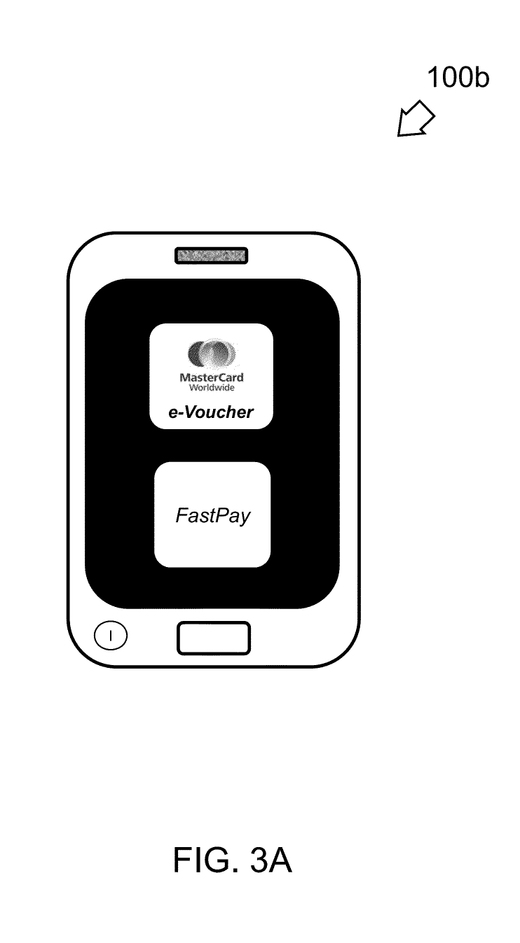

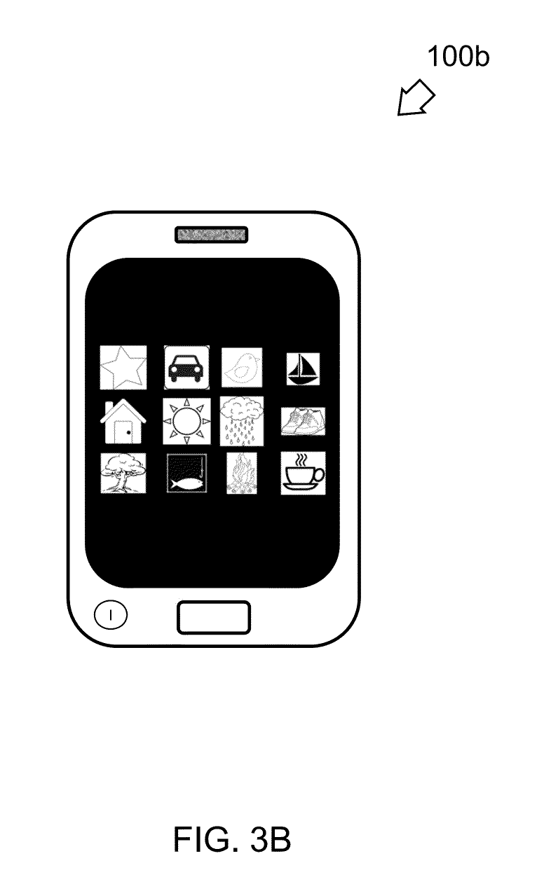

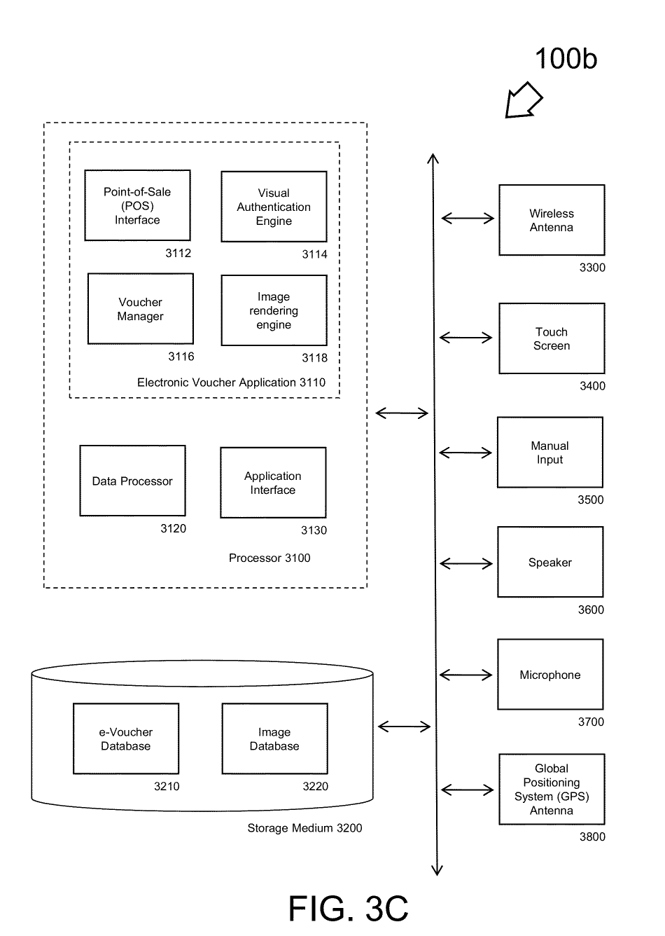

Turning to FIGS. 3A-C, these figures depict an electronic voucher device, constructed and operative in accordance with an embodiment of the present disclosure.

FIG. 3A shows an electronic voucher device displaying a menu selection embodiment, allowing the selection of an electronic voucher or an alternate payment method.

FIG. 3B illustrates an electronic voucher device 100b displaying pictograms or pictures as part of an authentication process embodiment. The electronic voucher device 100b is encoded with the electronic voucher information, including the number of unredeemed vouchers and authentication information. The authentication information may be a biometric component, such as an electronic image of the aid recipient. The electronic image of the aid recipient may be a Graphics Interchange Format (GIF), Joint Photographic Experts Group (JPEG), or other image format known in the art. During authentication of the electronic voucher device 100b, aid recipients may asked to type in a Visual personal identification image (VPII), an authentication using pictograph or image selection or sequence. The VPII is selected by the aid recipient in advance of the voucher transaction. During authentication, the aid recipient selects the images that constitute the VPII. In some embodiments, the VPII may require images to be selected sequentially; in other embodiments, the selection of images need not be sequential, but all the images of the VPII must be identified. The images or pictographs used may vary from one disaster-relief area to another.

Once the aid recipient is authenticated, the NGO mobile POS device 1112 verifies that there are an adequate number of unredeemed vouchers, and then decrements the number of unredeemed voucher by the amount corresponding to the goods or services received by the aid recipient.

FIG. 3C is a block diagram of the electronic voucher device 100b embodiment. When used in conjunction with a NGO mobile POS device 1112, electronic voucher device 100b may be used to assist in enabling electronic voucher redemption. In this example, electronic voucher device 100b is a mobile phone. Electronic voucher device 100b may be a mobile phone, tablet computer, personal digital assistant (PDA) or other portable computing device known in the art capable of communicating electronic voucher information to the NGO mobile POS device 1112.

Electronic voucher device 100b may run a real-time operating system (OS) and include at least one processor or central processing unit (CPU) 3100, a non-transitory computer-readable storage medium 3200, and an antenna 3300. An example operating system may include Apple iOS, Google Android Operating System, Blackberry OS, FireFox mobile operating system, Microsoft Windows, and the like. Electronic voucher device 100b may further include a screen or display device 3400, manual input 3500, speaker 3600, microphone 3700, and Global Positioning System (GPS) antenna 3800.

Processor 3100 may be any central processing unit, microprocessor, micro-controller, computational device or circuit known in the art. It is understood that processor 3100 may temporarily store instructions and data in Random Access Memory (not shown).

As shown in FIG. 3, processor 3100 is functionally comprised of an electronic voucher application 3110, a data processor 3120, and application interface 3130.

Electronic voucher application 3110 enables the functionality for the aid recipient to redeem an electronic voucher. Electronic voucher application 3110 may further comprise: point-of-sale interface 3112, visual authentication engine 3114, voucher manager 3116, and image rendering engine 3118.

A point-of-sale interface 3112 is a program or service that that communicates with NGO mobile point-of-sale device 1112. Point-of-sale interface 3112 may communicate using wireless antenna 3300 using Near Field Communication (NFC), Bluetooth, Wi-Fi or other wireless standard known in the art.

Visual authentication engine 3114 is configured to authenticate the aid recipient using non-written communication of a Visual personal identification image, and may do so in conjunction with image rendering engine 3118. Image rendering engine 3118 is configured to render images stored in an image database 3220. These stored images may include pictures or pictograms used for a Visual personal identification image, and may include a picture of the aid recipient.

Voucher manager 3116 is configured to track electronic voucher usage and supply, and may store its information in an e-Voucher database 3210.

Data processor 3120 enables processor 3100 to interface with storage media 3200, antenna 3300, screen 3400, manual input 3500, speaker 3600, microphone 3700, GPS antenna 3800, computer memory or any other component not on the processor 3100. The data processor 3120 enables processor 3100 to locate data on, read data from, and write data to these components.

Application interface 3130 may be any graphical user interface known in the art to facilitate communication with the user of the electronic voucher device 100b; as such, application interface 3130 may communicate with the user via screen 3400, manual input 3500, speaker 3600, or microphone 3700.

These structures may be implemented as hardware, firmware, or software encoded on a computer readable medium, such as storage media 3200. Further details of these components are described with their relation to method embodiments below.

Antenna 3300 may be any data port as is known in the art for interfacing, communicating or transferring data across a telecommunications network, computer network, Bluetooth, Wi-Fi, near-field communications, contactless point-of-sale network, and the like. Examples of such a network include a digital cellular telephony network. Antenna 3300 allows electronic voucher device 100b to communicate via a digital cellular telephony network. Furthermore, antenna 3300 allows electronic voucher device 100b to detect and communicate with NGO mobile point-of-sale device 1112.

Screen 3400 may be any liquid crystal display (LCD) display, light emitting diode (LED) screen, touch-sensitive screen, or other monitor known in the art for visually displaying images and text to a user.

Manual input 3500 may be buttons, a conventional keyboard, keypad, track pad, trackball, or other input device as is known in the art for the manual input of data. In some embodiments, manual input 3500 may be integrated into a touch-sensitive screen 3400. In other embodiments, manual input 3500 may be a virtual keyboard.

In addition, a speaker 3600 may be attached for reproducing audio signals from processor 3100. Speaker 3600 may also be able to generate ultrasonic signals for detection by sensors 1100. Microphone 3700 may be any suitable microphone as is known in the art for providing audio signals to processor 3100. Microphone 3700 is also configured to receive ultrasonic signals from sensors 1100.

GPS antenna 3800 is satellite-based navigation antenna that allows electronic voucher device 100b to ascertain its location by triangulating with satellites as one skilled in the art can appreciate.

It is understood that microphone 3700, speaker 3600, and GPS antenna 3800 may include appropriate digital-to-analog and analog-to-digital conversion circuitry as appropriate.

Storage medium 3200 may be a conventional read/write memory, such as a flash memory, memory stick, transistor-based memory, or other computer-readable memory device as is known in the art for storing and retrieving data.

In addition, as shown in FIG. 3, storage medium 3200 may store the e-Voucher database 3210, and image database 3220. When present, e-Voucher database 3210 is a data structure or database that contains electronic voucher information, which may include, but is not limited to: voucher account information, number of unredeemed vouchers, expiration dates and aid recipient name. In embodiments that also support financial transactions, e-Voucher database 3210 may further include a payment card information (such as primary account number (PAN), expiration dates and accountholder name), and electronic checking account numbers.

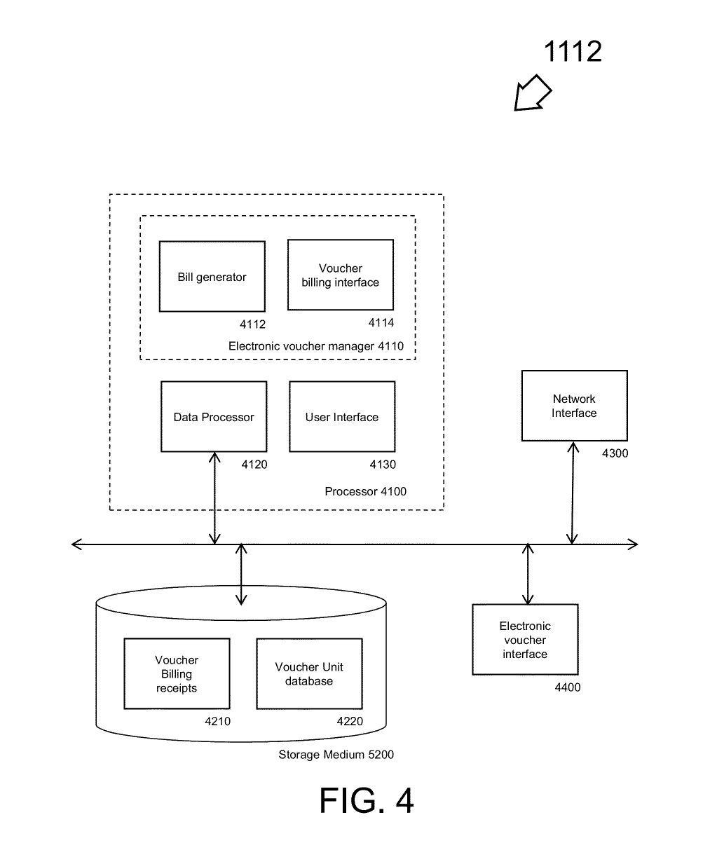

FIG. 4 is a block diagram of a NGO mobile point-of-sale device 1112 embodiment, constructed and operative in accordance with an embodiment of the present disclosure. NGO mobile point-of-sale device 1112 may be used at a merchant 1110, and may be supplied to the merchant 1110 by the NGO for use in conjunction with aid distribution via electronic vouchers.

NGO mobile POS device 1112 may run a multi-tasking operating system (OS) and include at least one processor or central processing unit (CPU) 5100, a non-transitory computer-readable storage medium 5200, and a network interface 5300. An example operating system may include Apple iOS, Google Android Operating System, Blackberry OS, Firefox mobile operating system, Microsoft Windows, and the like.

Processor 4100 may be any central processing unit, microprocessor, micro-controller, computational device or circuit known in the art. It is understood that processor 4100 may communicate with and temporarily store information in Random Access Memory (RAM) (not shown).

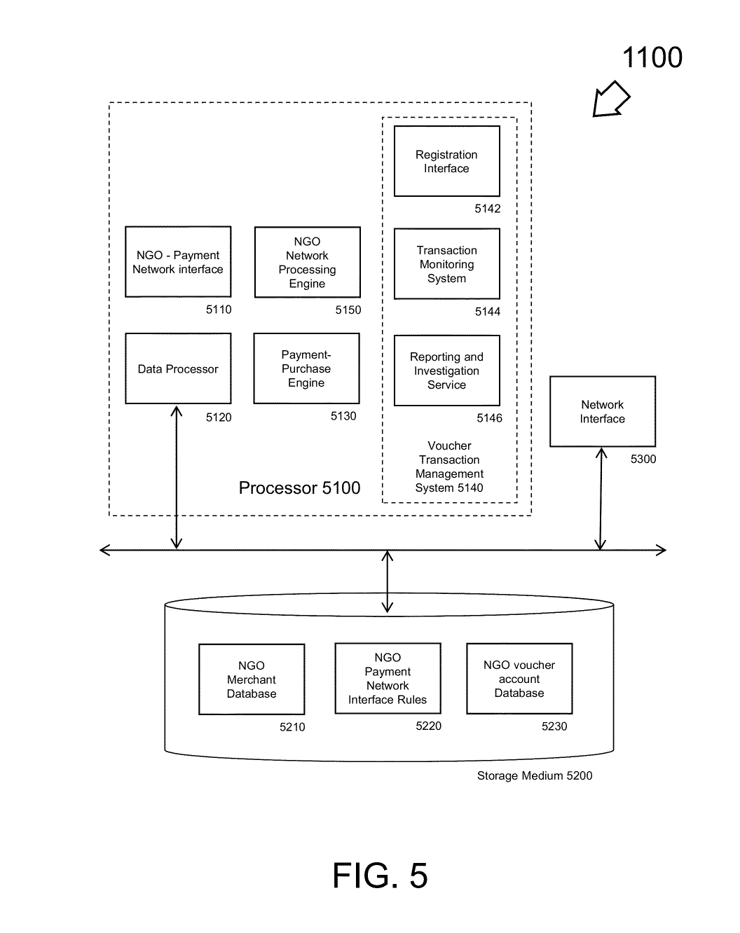

As shown in FIG. 5, processor 5100 is functionally comprised of an electronic voucher manager 4110, a data processor 5120, and user interface 5130.

Electronic voucher manager 4110 is a component configured to perform risk estimation by analyzing financial transactions. Electronic voucher manager 4110 may further comprise: a bill generator 4112, and voucher billing interface 4114.

Bill generator 4112 is the component of electronic voucher manager 4110 that generates an itemized bill based on items ordered or redeemed by aid recipient. Bill generator 4112 may access a voucher unit database 4220 for the redemption value of vouchers, goods, and services.

Voucher billing interface 4114 is the structure or component capable of processing electronic billing, including electronic presentation of bills generated by bill generator 4112, and electronic payments received (via an electronic voucher interface 4400) from an electronic voucher 100. Voucher billing interface 4114 may store voucher billing receipts 4210 in a database.

Data processor 4120 enables processor 4100 to interface with storage medium 4200, network interface 4300, electronic voucher interface 4400 and any other component not on the processor 4100. The data processor 4120 enables processor 4100 to locate data on, read data from, and write data to these components.

User interface 4130 is any structure that allows shopkeepers, wait staff, and merchant employees to enter orders and access electronic voucher manager 4110.

These structures may be implemented as hardware, firmware, or software encoded on a computer readable medium, such as storage medium 5200. Further details of these components are described with their relation to method embodiments below.

Network interface 4300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 4300 allows NGO mobile POS device 1112 to communicate with NGO network 1100.

Electronic voucher interface 4400 is any data port known in the art configured to read/write data from an electronic voucher card 100a or communicate with an electronic voucher device 100b. In some embodiments, electronic voucher interface 4400 can be a payment card reader/writer. In other embodiments, electronic voucher interface 4400 is a device configured to wirelessly communicate with electronic voucher device 100b; example electronic voucher interfaces include, but are not limited to: Infra-Red (IR), Bluetooth, contactless, or Near Field Communication interfaces.

Computer-readable storage medium 4200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data.

In addition, as shown in FIG. 4, storage medium 4200 may also contain voucher billing receipts 4210, and a voucher unit database 4220. Voucher billing receipts 4210 is configured to store records of billing transactions created by bill generator 4112 and paid via voucher billing interface 4114. Voucher unit database 4220 is a data structure configured to store for the redemption value of vouchers, goods, and services at a merchant; for example, in a food market setting, voucher unit database 4220 contains the redemption value of a voucher for food available at the market.

FIG. 5 is a block diagram of a NGO network 1100 embodiment, constructed and operative in accordance with an embodiment of the present disclosure. In embodiments that are intermittently connected to merchant 1110, NGO mobile POS device 1112 is brought into contact with NGO network 1100 to facilitate tracking of electronic vouchers. In embodiments that are electronically connected to merchant 1110, NGO network 1100 may authorize electronic voucher and communicate restricted cash transactions, and may do so in conjunction with payment network 6000; in such embodiments, NGO network 1100 is configured to process financial transactions that traverse an NGO network with a payment network 6000.

NGO network 1100 may run a multi-tasking operating system (OS) and include at least one processor or central processing unit (CPU) 5100, a non-transitory computer-readable storage medium 5200, and a network interface 5300.

Processor 5100 may be any central processing unit, microprocessor, micro-controller, computational device or circuit known in the art. It is understood that processor 5100 may communicate with and temporarily store information in Random Access Memory (RAM) (not shown).

As shown in FIG. 5, processor 5100 is functionally comprised of a NGO network processing engine 5150, NGO-payment network interface 5110, a payment purchase engine 5130, a voucher transaction management system 5140, and a data processor 5120.

NGO network processing engine 5150 is any structure that enables the NGO network 1100 to communicate with and process data and/or transactions, including from merchants 1110, and ATMs 1120. In some embodiments, this functionality may be handled by payment network 6000.

NGO-payment network interface 5110 is the structure that allows NGO network 1100 and payment network 6000 to communicate with each other. NGO-payment network interface 5110 may apply a set of rules that govern the types of transactions that may occur between payment network processing engine 5112 and NGO network processing engine 5150. These rules may be referred to as NGO-payment network interface rules 5220.

Fraud scoring engine 5118 is a structure that scores financial transactions from payment network processing engine 5112 and/or NGO network processing engine 5150 for fraud. Fraud scoring engine 5118 may use decision tree logic, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Payment-purchase engine 5130 may be any structure that facilitates voucher transactions or payment from customer accounts at an issuer 2300, or NGO 1200 to an ATM 1120/2120 or merchant 1110/2110. The customer accounts may include electronic voucher accounts, payment card accounts, checking accounts, savings accounts and the like.

Voucher transaction management system 5140 is configured to manage the NGO transactions on an NGO network 1100. In some embodiments, voucher transaction management system 5140 further comprises: registration interface 5142, transaction monitoring system 5144, and reporting and investigation service 5146.

Registration interface 5142 is a structure that allows the program manager to establish the NGO program rules, such as identifying registered merchants and aid recipients, and enable their participation through the provision or sanction of an appoint of sale system and electronic voucher, respectively.

In embodiments where NGO network 1100 is in direct communication with merchant 1110, transaction monitoring system 5144 enables a NGO-point-of-sale device (POS) to validate the authenticity of a voucher, grants aid recipients permission to use the voucher, and verifies the appropriateness of the merchant/aid-recipient combination, In some embodiments, the transaction monitoring system 5144 further enables an aid recipient or merchant 1110 to determine the number of unredeemed electronic vouchers and the available commodities for the aid recipient, and tracking of completed transactions that use the electronic voucher.

Reporting and investigation service 5146 is the electronic service that allows transactions to be monitored and allows registered entities to audit, investigate, analyze, and report transaction activity. In some embodiments this functionality includes the program management capability to interface with payment-purchase engine 5130, to compensate a merchant 1110 for goods and services rendered.

Data processor 5120 enables processor 5100 to interface with storage medium 5200, network interface 5300 or any other component not on the processor 5100. The data processor 5120 enables processor 5100 to locate data on, read data from, and write data to these components.

These structures may be implemented as hardware, firmware, or software encoded on a computer readable medium, such as storage medium 5200. Further details of these components are described with their relation to method embodiments below.

Network interface 5300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 5300 allows NGO network 1100 to communicate with vendors, accountholders, and/or issuer financial institutions.

Computer-readable storage medium 5200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 5200 may be remotely located from processor 5100, and be connected to processor 5100 via a network such as a local area network (LAN), a wide area network (WAN), or the Internet.

In addition, as shown in FIG. 5, storage medium 5200 may also contain a NGO voucher account database 5230, NGO merchant database 5210, and NGO payment network interface rules 5210. A NGO voucher account database 5230 is configured to store NGO payment accountholder information, such as NGO payment card and account information, NGO transaction information related to NGO accountholder accounts, and any other NGO payment accountholder-related information. NGO merchant database 5210 is configured to store NGO-approved merchant information, such as their account information. As described above, NGO-payment network interface rules 5220 include a set of rules and restrictions that govern the types of transactions that may occur between payment network processing engine 5112 and NGO network processing engine 5150 (“cross-network interface rules”). For illustrative purposes only, example NGO-payment network interface rules 5220 may include limitations on the types of merchants that an NGO-aid-recipient may pay outside the NGO network 1100; for example, the NGO-aid recipient may be restricted to purchases of food or temporary shelter. Another example limitation may include the amount of cash that an NGO-aid-recipient may withdraw from an ATM 2120 outside the NGO network 1100.

These structures may be implemented as hardware, firmware, or software encoded on a non-transitory computer readable medium, such as storage media. Further details of these components are described with their relation to method embodiments below.

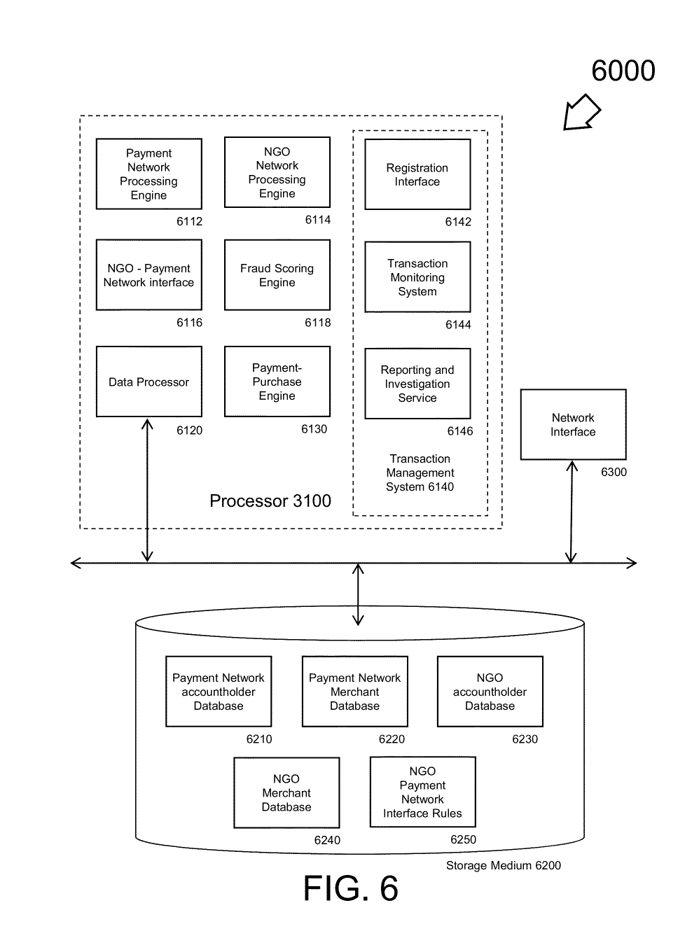

FIG. 6 is a block diagram of a payment network 6000, constructed and operative in accordance with an embodiment of the present disclosure. Payment network 6000 is configured to process electronic restricted cash vouchers that traverse an NGO network 1100, constructed and operative in accordance with an embodiment of the present disclosure.

Payment network 6000 may run a multi-tasking operating system (OS) and include at least one processor or central processing unit (CPU) 6100, a non-transitory computer-readable storage medium 6200, and a network interface 6300.

Processor 6100 may be any central processing unit, microprocessor, micro-controller, computational device or circuit known in the art. It is understood that processor 6100 may communicate with and temporarily store information in Random Access Memory (RAM) (not shown).

As shown in FIG. 6, processor 6100 is functionally comprised of a payment network processing engine 6112, NGO network processing engine 6114, NGO-payment network interface 6116, a fraud scoring engine 6118, a payment purchase engine 6160, a transaction management system 6140, and a data processor 6120.

Payment network processing engine 6112 is the structure that enables the payment network 6000 to communicate with and process data and/or transactions via the interbank network 2100, including from acquirer 2200 and issuer 2600.

NGO network processing engine 6114 is any structure that enables the payment network 6000 to communicate with and process data and/or transactions via the NGO network 1100, including from merchants 1110, ATMs 1120.

NGO-payment network interface 6116 the structure that allows payment network processing engine 6112 and NGO network processing engine 6114 to communicate with each other. NGO-payment network interface 6116 may apply a set of rules that govern the types of transactions that may occur between payment network processing engine 6112 and NGO network processing engine 6114. These rules may be referred to as NGO-payment network interface rules 6250.

Fraud scoring engine 6118 is a structure that scores voucher and/or financial transactions from payment network processing engine 6112 and/or NGO network processing engine 6114 for fraud. Fraud scoring engine 6118 may use decision tree logic, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Payment-purchase engine 6130 may be any structure that facilitates payment from customer accounts at an issuer 2300, or NGO network 1100 to an ATM 1120/2120 or merchant 1110/2110. The customer accounts may include payment card accounts, checking accounts, savings accounts and the like.

Transaction management system 6140 is configured to manage the NGO transactions on an NGO network 1100. In some embodiments, transaction management system 6140 further comprises: registration interface 6142, transaction monitoring system 6144, and reporting and investigation service 6146.

Registration interface 6142 is a structure that allows the program manager to establish the NGO program rules, such as identifying registered merchants and aid recipients, and enable their participation through the provision or sanction of an appoint of sale system and voucher, respectively.

Transaction monitoring system 6144 enables a merchant point of sale device (POS) to validate the authenticity of a voucher, grants aid recipients permission to use the voucher, and verifies the appropriateness of the merchant/aid-recipient combination, In some embodiments, the transaction monitoring system 6144 further enables an aid recipient or merchant 1110 to determine the balance on the voucher and the available commodities for the aid recipient, and tracking of completed transactions that use the voucher.

Reporting and investigation service 6146 is the electronic service that allows transactions to be monitored and allows registered entities to audit, investigate, analyze, and report transaction activity. In some embodiments this functionality includes the program management capability to interface with payment-purchase engine 6130, to compensate a merchant 1110 for goods and services rendered.

Data processor 6120 enables processor 6100 to interface with storage medium 6200, network interface 6300 or any other component not on the processor 6100. The data processor 6120 enables processor 6100 to locate data on, read data from, and write data to these components.

These structures may be implemented as hardware, firmware, or software encoded on a computer readable medium, such as storage medium 6200. Further details of these components are described with their relation to method embodiments below.

Network interface 6300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 6300 allows payment network 6000 to communicate with vendors, accountholders, and/or issuer financial institutions.

Computer-readable storage medium 6200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 6200 may be remotely located from processor 6100, and be connected to processor 6100 via a network such as a local area network (LAN), a wide area network (WAN), or the Internet.

In addition, as shown in FIG. 6, storage medium 6200 may also contain a payment network accountholder database 6210, payment network merchant database 6220, NGO accountholder database 6230, NGO merchant database 6240, and NGO payment network interface rules 6250. Payment network accountholder database 6210 is configured to store payment accountholder information, such as payment card and account information, transaction information related to accountholder accounts, and any other payment accountholder-related information. Payment network merchant database 6220 is configured to store merchant information, such as merchant account information. A NGO accountholder database 6230 is configured to store NGO payment accountholder information, such as NGO payment card and account information, NGO transaction information related to NGO accountholder accounts, and any other NGO payment accountholder-related information. NGO merchant database 6240 is configured to store NGO-approved merchant information, such as their account information. As described above, NGO-payment network interface rules 6250 include a set of rules and restrictions that govern the types of transactions that may occur between payment network processing engine 6112 and NGO network processing engine 6114 (“cross-network interface rules”). For illustrative purposes only, example NGO-payment network interface rules 6250 may include limitations on the types of merchants that an NGO-aid-recipient may pay outside the NGO network 1100; for example, the NGO-aid recipient may be restricted to purchases of food or temporary shelter. Another example limitation may include the amount of cash that an NGO-aid-recipient may withdraw from an ATM 2120 outside the NGO network 1100.

These structures may be implemented as hardware, firmware, or software encoded on a non-transitory computer readable medium, such as storage media. Further details of these components are described with their relation to method embodiments below.

An electronic restricted cash vouchers embodiment leverages a payment network 6000 where the infrastructure is used for tracking and reporting rather than payment. In both cash and commodity voucher situations, the fiduciary transactions are separate from the tracking.

Cash-out is a two-step process versus a single step process: the consumer never “owns” the money they are withdrawing and the NGO is not reliant on the payments network to deliver payment settlement. This is a separate function in the system, versus an interwoven function.

Embodiments put technology and business practices at the center of a laddering system of vouchers within domestic and international payment networks. A single technology platform allows consumers to ladder from voucher to cash-out to participation in a domestic network and upwards through participation in an international network. In one embodiment, a platform and centralized infrastructure allows everything from restricted commodities to cash to full payment enablement to connectivity between points of acceptance and Cash-In/Cash-Out (CICO), a service provided by an affiliate of the network where a consumer can either deposit or withdraw cash to/from their account.

The embodiments enable implementation of an electronic voucher system on electronic voucher cards 100a, without the pre-emptive engagement of a financial institution. This leads to more flexible initiation by constructing business rules and implementing technologies that enable the electronic vouchers, but protect the payment system 1000.

As embodiments offer tracking services, not payment services, non-financial institutions can leverage the network to issue tokens and serve as providers of these services. It is understood that non-financial institutions may have unique and differentiated franchise rules, legal structures, and pricing models. Embodiments enable an electronic voucher token to transition to a payment account system owned by a financial institution without necessarily requiring the reissuance of cards.

An embodiment system fosters the collection and management of data on consumer and merchant behavior. Observed behaviors (i.e., usage history, spending habits) can be leveraged to transition clients to a formal relationship with a financial institution, quickening and easing the process of financial inclusion. A tracking system creates record of payment flows, consumer spending habits, and additional information that a merchant can leverage with wholesalers, financial institutions and suppliers.

The NGO may package and sell the collected know-your-customer (KYC)/behavioral data to a financial institution and use the revenue to offset program costs. If an NGO sells the portfolio to the financial institution, the financial institution can enable payment functionality on the form factor concurrent with voucher programs.

Using an embodiment system, the NGO creates valuable assets for both consumers and merchants through the tracking of usage history and spending habits. Behavioral spend information allows financial institutions to cross sell products and offer more sophisticated, targeted financial services (i.e., insurance, credit extension) beyond a traditional payment card.

An embodiment, including the creation of necessary know-your-customer (KYC) resources, enables a NGO voucher system merchant point-of-sale (POS) devices 1112 to be transitioned to an open network merchant acceptance device and account owned by a financial institution without necessarily requiring the reissuance of the POS device.

The NGO mobile POS device 1112 used by a merchant 1110 for voucher acceptance is “locked” to the electronic voucher system until the merchant is sanctioned to operate on the private or broader domestic and international payments networks. Sophisticated capabilities are loaded, but are not available at the outset until program managers “unlock” capabilities over time for additional enablement. This process does not require the merchant to receive new hardware.

All changes in the status of the card or mobile point of sale (MPOS) device is collected, consolidated and shared with the central database and other participating stakeholders.

Embodiments may include an electronic consumer-merchant voucher system that meets necessary control requirements using photographic authentication. The standards (branding, rules, and the like) for a payment network card versus a voucher card may be different. Two and three factor photo validation may be enabled: photo is printed on the card, photo is stored on a chip that is read by the NG mobile POS device 1112, and individual is present for comparison with photo. Consequently, the individual/beneficiary/recipient is not required to remember a PIN or a code. This is especially helpful when deployed in an environment where illiteracy is high.

In some embodiments, visual personal identification image authentication may be used. The use of visual personal identification image authentication recognizes that low levels of literacy and pin functionality occur throughout the world. Such an embodiment allows a recipient to use images in place of numbers for a VPII. Visual personal identification image entry can be mandated as a particular length and order, or a sequence of images in a non-specific order. For example, the images (or icons) may be provided to a user, and the user will have to select specific images as a VPII.

An electronic voucher system embodiment allows multiple NGO programs to exist on a single token; streamlining the registration process, unconflicting the assignment of benefits, and managing risk. All NGOs that have services on the card will be notified of fraudulent activities/loss of card and can shut off functionality as needed. The shared infrastructure provides support and opportunities for merchants 1110 who concurrently provide commodities to multiple NGOs. A centralized database and shared infrastructure allow information to be collected and easily accessed within a single platform infrastructure.

Because NGOs have relationship with a centralized database, the tools and MPOS can be shared and tracked in a uniform fashion. A consumer can use one card for multiple NGOs, and a merchant can use one MPOS for multiple NGO programs.

To enable the embodiments described, it is understood that hardware, software, and firmware encoded on to non-transitory computer readable media are utilized.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and features disclosed herein.

What is claimed is:

1. A method of processing an electronic voucher transaction, the method comprising:
reading electronic voucher information with an electronic voucher interface, the electronic voucher information containing: a cardholder identifier, and a number of unredeemed electronic vouchers;
totaling, with a processor, a number of goods or services to be redeemed with an electronic voucher;
calculating the number of vouchers required to redeem the number of goods or services with the processor;
comparing, with the processor, the number of unredeemed electronic vouchers and the calculated number of vouchers required to redeem the number of goods or services;
denying, with the processor, the electronic voucher transaction when the number of unredeemed electronic vouchers is less than the calculated number of vouchers required to redeem the number of goods or services.

2. The method of claim 1, further comprising:
subtracting the calculated number vouchers required to redeem the number of goods or services from the number of unredeemed electronic vouchers, resulting in an updated number of unredeemed electronic vouchers.

3. The method of claim 2 further comprising:
writing, with the electronic voucher interface, the updated number of unredeemed electronic vouchers to an electronic voucher card or electronic voucher device.

4. The method of claim 3 wherein the electronic voucher information further contains a visual personal identification image (VPII).

5. The method of claim 4 further comprising:
prompting an electronic voucher redeemer to enter the visual personal identification image to authenticate the electronic voucher redeemer.

6. The method of claim 5 wherein the visual personal identification image is a selection of non-written pictographs or pictures.

7. The method of claim 6 further comprising:
denying the electronic voucher transaction when the processor cannot authenticate the electronic voucher redeemer.

8. A system to enable trading of network restricted cash vouchers, comprising:
an electronic voucher interface configured to read electronic voucher information, the electronic voucher information containing: a cardholder identifier, and a number of unredeemed electronic vouchers;
a processor configured to total a number of goods or services to be redeemed with an electronic voucher, to calculate the number of vouchers required to redeem the number of goods or services, to compare the number of unredeemed electronic vouchers and the calculated number of vouchers required to redeem the number of goods or services, and to deny the electronic voucher transaction when the number of unredeemed electronic vouchers is less than the calculated number of vouchers required to redeem the number of goods or services.

9. The system of claim 8 wherein the processor is further configured to subtract the calculated number vouchers required to redeem the number of goods or services from the number of unredeemed electronic vouchers, resulting in an updated number of unredeemed electronic vouchers.

10. The system of claim 9 wherein the electronic voucher interface is further configured to write the updated number of unredeemed electronic vouchers to an electronic voucher card or electronic voucher device.

11. The system of claim 10 wherein the electronic voucher information further contains a visual personal identification image (VPII).

12. The system of claim 11 further wherein the processor is further configured to prompt an electronic voucher redeemer to enter the visual personal identification image to authenticate the electronic voucher redeemer.

13. The system of claim 12 wherein the visual personal identification image is a selection of non-written pictographs or pictures.

14. The system of claim 13 wherein the processor is further configured to denying the electronic voucher transaction when the processor cannot authenticate the electronic voucher redeemer.

15. A non-transitory computer-readable storage medium encoded with data and instructions that when executed by a computing device cause the computing device to:
read electronic voucher information with an electronic voucher interface, the electronic voucher information containing: a cardholder identifier, and a number of unredeemed electronic vouchers;
total, with a processor, a number of goods or services to be redeemed with an electronic voucher;
calculate the number of vouchers required to redeem the number of goods or services with the processor;
compare, with the processor, the number of unredeemed electronic vouchers and the calculated number of vouchers required to redeem the number of goods or services;
deny, with the processor, the electronic voucher transaction when the number of unredeemed electronic vouchers is less than the calculated number of vouchers required to redeem the number of goods or services.

16. The non-transitory computer-readable medium of claim 15, wherein the instructions further cause the computing device to:
subtract the calculated number vouchers required to redeem the number of goods or services from the number of unredeemed electronic vouchers, resulting in an updated number of unredeemed electronic vouchers.

17. The non-transitory computer-readable medium of claim 16 wherein the instructions further cause the computing device to:
write, with the electronic voucher interface, the updated number of unredeemed electronic vouchers to an electronic voucher card or electronic voucher device.

18. The non-transitory computer-readable medium of claim 17 wherein the electronic voucher information further contains a visual personal identification image (VPII).

19. The non-transitory computer-readable medium of claim 18 wherein the instructions further cause the computing device to:
prompt an electronic voucher redeemer to enter the visual personal identification image to authenticate the electronic voucher redeemer.

20. The non-transitory computer-readable medium of claim 19 wherein the visual personal identification image is a selection of non-written pictographs or pictures.
